(19) United States
(12) Patent Application Publication
(10) Pub. No.: US 2009/0230347 A1
(43) Pub. Date: Sep. 17, 2009

(54) FORMULATION COMPRISING A POLYMERIZABLE MONOMER AND/OR A POLYMER AND, DISPERSED THEREIN, A SUPERPARAMAGNETIC POWDER

(75) Inventors: Markus Pridöhl, Grosskrotzenburg (DE); Guido Zimmermann, Brühl (DE); Michael Kröll, Linsengericht (DE); Harald Häger, Lüdinghausen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: DEGUSSA GmbH, Duesseldorf (DE)

(21) Appl. No.: 11/720,613

(22) PCT Filed: Nov. 29, 2005
(86) PCT No.: PCT/EP05/12714

§ 371 Date: Jun. 1, 2007

(30) Foreign Application Priority Data
Dec. 1, 2004 (DE) 10 2004 057 830.3
Oct. 14, 2005 (DE) 10 2005 049 136.7

(51) Int. Cl. H01F 1/26; C09J 5/06; H05B 6/80

(52) U.S. Cl. 252/62.54; 219/678

(57) ABSTRACT

Formulation comprising a polymerizable monomer and/or a polymer and, dispersed therein, a superparamagnetic powder, which comprises aggregated primary particles, the primary particles being built up from magnetic metal oxide domains having a diameter of from 2 to 100 nm in a nonmagnetic metal oxide or metalloid oxide matrix. Process for heating the formulation in a magnetic or electromagnetic alternating field. Use of the formulation as an adhesive composition.

The invention relates to a formulation comprising a polymerizable monomer and/or a polymer and, dispersed therein, a superparamagnetic powder. The invention furthermore relates to a process for heating the formulation.

DE-A-19924138 claims an adhesive composition which comprises, inter alia, nanoscale particles having superparamagnetic properties

DE-A-10163399 describes a nanoparticulate formulation which has a coherent phase and at least one particulate phase, dispersed therein, of superparamagnetic, nanoscale particles. The particles have a volume-average particle diameter in the range of from 2 to 100 nm and contain at least one metal mixed oxide of the general formula M^{II}M^{III}O₄, wherein M^{II} represents a first metal component which comprises at least two divalent metals which differ from one another and M^{III} represents a further metal component which comprises at least one trivalent metal. The coherent phase can comprise water, an organic solvent, a polymerizable monomer, a polymer and mixtures. In this context, formulations in the form of an adhesive composition are preferred.

It applies both to DE-A-19924138 and to DE-A-10163399 that in order to prevent an agglomeration or fusion of the nanoscale particles and/or in order to ensure a good dispersibility of the particulate phase in the coherent phase, the particles employed are preferably surface-modified or surface-coated. A disadvantage here is that the substances employed for the surface coating or surface modification can become detached, especially at high temperatures and/or under mechanical influences. The consequence of this is that the nanoscale particles can agglomerate or coalesce, as a result of which their superparamagnetic properties are lost.

The Theological properties of the nanoparticulate formulation according to DE-A-10163399 or of the adhesive composition according to DE-A-19924138 can be adjusted in a wide range by the nature and amount of the dispersing agent. However, it is not possible or possible to only a limited extent to adjust the rheology of the formulation by the nanoscale, superparamagnetic particles themselves, since the superparamagnetic properties are bound to certain particle sizes. The particles are advantageously present in the formulation virtually as primary particles, as a result of which adjustment of the rheology, for example a thickening, is possible only by simultaneous varying of the content of superparamagnetic particles.

The object of the present invention is to provide a formulation which comprises superparamagnetic particles and avoids the disadvantages of the prior art. In particular, the superparamagnetic particles should show no agglomeration in the formulation, even at high temperatures, and should be heat-stable. The superparamagnetic particles should furthermore show as far as possible a uniform distribution in the formulation. It should furthermore be possible to control the rheology of the formulation as far as possible independently of the content of superparamagnetic particles.

The object of the invention is furthermore to provide a process for heating the formulation.

The present invention provides a formulation comprising a polymerizable monomer and/or a polymer and, dispersed therein, a superparamagnetic powder, characterized in that the superparamagnetic powder consists of aggregated primary particles, the primary particles being built up from magnetic metal oxide domains having a diameter of from 2 to 100 nm in a nonmagnetic metal oxide or metalloid oxide matrix.

In the context of the invention, aggregated is to be understood as meaning three-dimensional structures of coalesced primary particles. Several aggregates can combine into agglomerates. These agglomerates can easily be separated again. In contrast to this, breakdown of the aggregates into the primary particles as a rule is not possible.

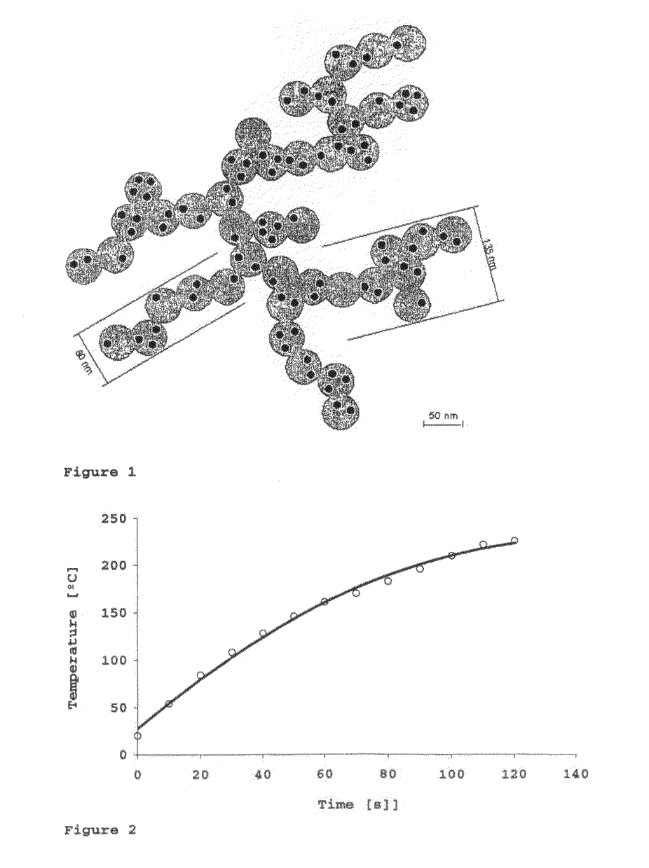

The aggregate diameter of the superparamagnetic powder can preferably be greater than 100 nm and less than 1 μm. Preferably, the aggregates of the superparamagnetic powder can have a diameter of not more than 250 nm in at least one spatial direction. These circumstances are illustrated in FIG. 1, in which two side arms of an aggregate have diameters of 80 nm and 135 nm.

Domains are to be understood as meaning regions in a matrix which are separated spatially from one another. The domains of the superparamagnetic powder have a diameter of between 2 and 100 nm.

The domains can also have nonmagnetic regions, which make no contribution to the magnetic properties of the powder.

In addition, magnetic domains which, because of their size, show no superparamagnetism and induce retentivity can also be present. This leads to an increase in the volume-specific saturation magnetization. However, the content of these domains is low compared with the number of superparamagnetic domains. According to the present invention, the superparamagnetic powder contains such a number of superparamagnetic domains that the formulation according to the invention can be heated by means of a magnetic or electromagnetic alternating field.

The domains of the superparamagnetic powder can be enclosed completely or only partly by the surrounding matrix. Partly enclosed means that individual domains can project out of the surface of an aggregate.

The domains can contain one or more metal oxides.

The magnetic domains can preferably contain the oxides of iron, cobalt, nickel, chromium, europium, yttrium, samarium or gadolinium. In these domains, the metal oxides can be present in a uniform modification or in various modifications.

A particularly preferred magnetic domain is iron oxide in the form of gamma-Fe₂O₃ (γ-Fe₂O₃), Fe₃O₄, mixtures of gamma-Fe₂O₃ (γ-Fe₂O₃) and/or Fe₃O₄.

The magnetic domains can furthermore be present as a mixed oxide of at least two metals with the metal components iron, cobalt, nickel, tin, zinc, cadmium, magnesium, manganese, copper, barium, magnesium, lithium or yttrium.

The magnetic domains can furthermore be substances having the general formula M^{II}Fe₂O₄, wherein M^{II} represents a metal component which comprises at least two divalent metals which differ from one another. Preferably, one of the divalent metals can be manganese, zinc, magnesium, cobalt, copper, cadmium or nickel.

The magnetic domains can furthermore be built up from ternary systems of the general formula (M^{a}_{1-x-y}M^{b}ₓFe_{y})^{II}Fe₂^{III}O₄, wherein Ma, and Mb are the metals manganese, cobalt, nickel, zinc, copper, magnesium, barium, yttrium, tin, lithium, cadmium, magnesium, calcium, strontium, titanium, chromium, vanadium, niobium or molybdenum, where x=0.05 to 0.95, y=0 to 0.95 and x+y≦1.

ZnFe₂O₄, MnFe₂O₄, Mn_{0.6}Fe_{0.4}Fe₂O₄, Mn_{0.5}Zn_{0.5}Fe₂O₄, Zn_{0.1}Fe_{1.9}O₄, Zn_{0.2}Fe_{1.8}O₄, Zn_{0.3}Fe_{1.7}O₄, Zn_{0.4}Fe_{1.6}O₄ or Mn_{0.39}Zn_{0.27}Fe_{2.34}O₄, MgFe₂O₃, Mg_{1.2}Mn_{0.2}Fe_{1.6}O₄, Mg_{1.4}Mn_{0.4}Fe_{1.2}O₄, Mg_{1.6}Mn_{0.6}Fe_{0.8}O₄, Mg_{1.8}Mn_{0.8}Fe_{0.4}O₄ may be particularly preferred.

The choice of the metal oxide of the nonmagnetic matrix is not limited further. The oxides of titanium, zirconium, zinc, aluminium, silicon, cerium or tin may be preferred.

In the context of the invention, the metal oxides also include metalloid oxides, such as, for example, silicon dioxide.

The matrix and/or the domains can furthermore be in an amorphous and/or crystalline form.

The content of the magnetic domains in the powder is not limited, as long as the spatial separation of matrix and domains exists. The content of the magnetic domains in the superparamagnetic powder can preferably be 10 to 90 wt. %.

Suitable superparamagnetic powders are described, for example, in EP-A-1284485 and in the still unpublished German Patent Application with the Application Number 10317067.7-41 of 14 Mar. 2003, to which reference is made in the full scope.

The formulation according to the invention can preferably have a content of superparamagnetic powder in a range of from 0.1 to 40 wt. %.

Polymerizable monomers which are suitable for the formulation according to the invention can be those which lead to the polymers mentioned below. The conversion of these monomers into the polymers is known to the person skilled in the art.

Suitable polymers in the formulation according to the invention can preferably be a polymer which can be softened thermoplastically, a one- or two-component polyurethane, a one- or two-component polyepoxide, a one- or two-component silicone polymer, a silane-modified polymer, a polyamide, a (meth)acrylate-functional polymer, a polyester, a polycarbonate, a cycloolefin copolymer, a polysiloxane, a poly(ether)sulfone, a polyether ketone, a polystyrene, a polyoxymethylene, a polyamide-imide, a polytetrafluoroethylene, a polyvinylidene fluoride, perfluoroethylene/propylene copolymer, perfluoroalkoxy copolymer, a methacrylate/butadiene/styrene copolymer and/or a liquid crystal copolyester (LCP). Polyamide 12 powders may be particularly preferred.

The superparamagnetic powder of the formulation according to the invention can also be in the form of granules. The granules can be prepared, for example, by dispersing a superparamagnetic powder in water, spray drying the dispersion and heat-treating the resulting granules at a temperature of from 150 to 1,100° C. for a period of from 1 to 8 h. The spray drying can be carried out, for example, at a temperature of from 200 to 600° C. Disc atomizers or nozzle atomizers can be employed here. The heat treatment of the granules can be carried out either in a static bed, such as, for example, in chamber ovens, or in an agitated bed, such as, for example, rotary tubular dryers.

Furthermore, the formulation according to the invention can itself also be in the form of granules.

For this, for example, a mixture of a polymer in powder form and a superparamagnetic powder is extruded, pressed as a strand and then granulated. This form may be advantageous in particular for polyamide polymers.

In addition to polymerizable monomers and polymers, the formulation according to the invention can also comprise water or organic dispersing agents. Suitable-organic dispersing agents can be chosen, for example, from oils, fats, waxes, esters of C₆-C₃₀-monocarboxylic acids with mono-, di- or trihydric alcohols, saturated acyclic and cyclic hydrocarbons, fatty acids, low molecular weight alcohols, fatty alcohols and mixtures thereof. These include, for example, paraffin and paraffin oils, mineral oils, linear saturated hydrocarbons having as a rule more than 8 carbon atoms, such as tetradecane, hexadecane, octadecane etc., cyclic hydrocarbons, such as cyclohexane and decahydronaphthalene, waxes, esters of fatty acids, silicone oils etc. Linear and cyclic hydrocarbons and alcohols e.g. are preferred.

The present invention also provides a process for heating the formulation according to the invention, in which the formulation is exposed to a magnetic or electromagnetic alternating field.

Preferably, for heating, the formulation according to the invention is exposed to a magnetic alternating field having a frequency in the range of from 30 Hz to 100 MHz. The frequencies of the usual inductors, for example medium frequencies in a range of from 100 Hz to 100 kHz or high frequencies in a range of from 10 kHz to 60 MHz, in particular 50 kHz to 3 MHz, are suitable.

The nanoparticulate domains of the superparamagnetic powder allow a utilization of the energy input of the electromagnetic radiation available in a particularly effective manner.

The same applies analogously to heating by electromagnetic alternating fields of microwave radiation. In this context, microwave radiation having a frequency in the range of from 0.3 to 300 GHz is preferably employed. To adjust the resonance frequency, in addition to the microwave radiation, a direct current magnetic field having a field strength in the range of from about 0.001 to 10 tesla is preferably employed. The field strength is preferably in a range of from 0.015 to 0.045 tesla, and in particular 0.02 to 0.06 tesla.

The present invention also provides the use of the formulation according to the invention as an adhesive composition.

### EXAMPLES

### Preparation of the Superparamagnetic Powders

### Powder P-1:

0.57 kg/h SiCl₄ is vaporized at approx. 200° C. and fed into a mixing zone with 4.1 Nm³/h hydrogen and 11 Nm³/h air. In addition, an aerosol which is obtained from a 25 percent strength by weight aqueous iron(II) chloride solution (1.27 kg/h) is introduced into the mixing zone within the burner by means of a carrier gas (3 Nm³/h nitrogen). The homogeneously mixed gas/aerosol mixture burns there at an adiabatic combustion temperature of about 1,200° C. over a dwell time of about 50 msec. After the reaction, the reaction gases and the powder formed are cooled in a known manner and separated off from the stream of waste gas by means of a filter. In a further step, still adhering hydrochloric acid residues are removed from the powder by treatment with nitrogen containing steam.

### Powder P-2:

0.17 kg/h SiCl₄ is vaporized at approx. 200° C. and fed into a mixing zone with 4.8 Nm³/h hydrogen and 12.5 Nm³/h air. In addition, an aerosol which is obtained from a 25 percent strength by weight aqueous iron(II) chloride solution (2.16 kg/h) is introduced into the mixing zone within the burner by means of a carrier gas (3 Nm³/h nitrogen). The homogeneously mixed gas/aerosol mixture burns there at an adiabatic combustion temperature of about 1,200° C. over a dwell time of about 50 msec. After the reaction, the reaction gases and the powder formed are cooled in a known manner and separated off from the stream of waste gas by means of a filter. In a further step, still adhering hydrochloric acid residues are removed from the powder by treatment with nitrogen containing steam.

### Powder P-3:

0.14 kg/h SiCl₄ is vaporized at approx. 200° C. and fed into a mixing zone with 3.5 Nm³/h hydrogen and 15 Nm³/h air.

In addition, an aerosol which is obtained from a 10 percent strength by weight aqueous iron^{III} chloride solution by means of a two-component nozzle is introduced into the mixing zone within the burner by means of a carrier gas (3 Nm³/h nitrogen).

The homogeneously mixed gas/aerosol mixture burns there at an adiabatic combustion temperature of about 1,200° C. over a dwell time of about 50 msec.

After the reaction, the reaction gases and the silicon dioxide powder, doped with iron oxide, which has formed are cooled in a known manner and the powder is separated off from the stream of waste gas by means of a filter.

In a further step, still adhering hydrochloric acid residues are removed from the powder by treatment with nitrogen containing steam.

### Powder P-4:

0.57 kg/h of the matrix precursor SiCl₄ is vaporized at approx. 200° C. and fed into the reactor with 4 Nm³/h hydrogen as well as 11 Nm³/h air and 1 Nm³/h nitrogen.

In addition, an aerosol comprising the domains precursors, which is obtained from an aqueous iron(II) chloride, magnesium^{II}, manganese chloride solution by means of a two-component nozzle, is introduced into the reactor by means of a carrier gas (3 Nm³/h nitrogen). The aqueous solution contains 1.8 wt. % MnCl₂, 8.2 wt. % MgCl₂ and 14.6 wt. % FeCl₂.

The homogeneously mixed gas/aerosol mixture flows into the reactor and burns there at an adiabatic combustion temperature of about 1,350° C. over a dwell time of about 70 msec.

The dwell time is calculated from the quotient of the installation volume through which the mixture flows and the operating volume flow of the process gases at the adiabatic combustion temperature.

After the flame hydrolysis, the reaction gases and the silicon dioxide powder, doped with zinc magnesium ferrite, which has formed are cooled in a known manner and the solid is separated off from the stream of waste gas by means of a filter.

In a further step, still adhering hydrochloric acid residues are removed from the powder by treatment with nitrogen containing steam.

The physico-chemical data of the superparamagnetic powders P-1 to P-4 are reproduced in Table 1.

### Preparation of the Formulations

In each case 5 wt. %, based on the total mixture, of the superparamagnetic powders P-1 to P-4 are incorporated into the epoxy resin ERL 4221 (Dow, 3,4-epoxy-cyclohexyl-methyl 3,4-epoxycyclohexenecarboxylate) by means of an Ultra Turrax at 11,000 rpm in order to obtain the corresponding formulations F-1 to F-4. After 48 hours, the viscosity is measured at 23° C. as a function of the shear gradient (Rheolyst AR 1000-N, manufacturer: TA Instruments, measurement geometry: ball/plate, temperature: 23° C.). The viscosity values of the formulations are reproduced in Table 1.

Table 1 shows the possibilities of controlling the rheology and the Curie temperature during the preparation of the formulations according to the invention. All the formulations have the same content of superparamagnetic powder in the formulation.

F-1 and F-3 moreover have the same content of magnetic domains, but different BET surface areas. This leads to a formulation having a low viscosity in the case of F-1 and a formulation having a high viscosity in the case of F-3.

Comparison of formulations F-1 and F-2 shows that formulations having approximately the same viscosity with a different content of magnetic domains can be obtained.

Formulation F-4 shows, in comparison with F-1, that it is possible to obtain a formulation with approximately the same viscosity and a significantly lowered Curie temperature without changing the content of magnetic domains.

The present invention allows the preparation of tailor-made formulations in respect of rheology and Curie temperature, In contrast to the prior art, the rheology and the Curie temperature can be controlled by the properties of the superparamagnetic powders themselves, and not by additives.

TEM photographs show that the superparamagnetic powders show no agglomeration in the formulation, even at high temperatures.

In the prior art, the superparamagnetic powders are in a form which is surface-modified with organic substances to avoid agglomeration. The organic constituents are not stable at high temperatures and lead to a discoloration and to a reagglomeration of the superparamagnetic particles and therefore to a loss of superparamagnetic properties. In contrast to this, the formulation according to the invention, in which the superparamagnetic powder contains no surface-modifying organic substances, can be heated to high temperatures, without its superparamagnetic properties being lost.

### Formulation F-5:

A mixture of 20 parts by weight of Vestosint® 2157, Degussa AG, and 1 part by weight of powder P-1 is mixed in a high-speed mixer from MTI (model M20 FU) at room temperature at a speed of revolution of 1,500/min over a mixing time of 3 min. The heating-up curve of the formulation is then measured (FIG. 2).

### Formulation F-6:

Preparation as for formulation F-5, but using Vestamid® L1901 (designation according to ISO 1874-1: PA12, XN, 18-010), Degussa AG, instead of Vestosint® 2174.

The formulation is then mixed with melting in a ZE25-33D twin-screw extruder from Berstorff at 250° C. with a throughput of 10 kg/h, extruded and granulated.

### Formulation F-7:

A mixture of 10 parts by weight of Vestamid® L1901, Degussa AG, and 1 part by weight of powder P-2 is mixed in a high-speed mixer from MTI (model M20 FU) at room temperature at a speed of revolution of 1,500/min over a mixing time of 3 min.

The formulation is then mixed with melting in a ZE25-33D twin-screw extruder from Berstorff at 250° C. with a throughput of 10 kg/h, extruded and granulated.

TABLE 1
Physico-chemical values of the superparamagnetic
powders and the formulations

| | | Powder | | | |
|---|---|---|---|---|---|
| | | P-1 | P-2 | P-3 | P-4 |
| Matrix/domain | | SiO₂/ | SiO₂/ | SiO₂/ | SiO₂/ |
| | | Fe₂O₃* | Fe₂O₃* | Fe₂O₃* | Fe₂O₃*, |
| | | | | | MnO, |
| | | | | | MgO** |
| Content of domain | wt. % | 50 | 85 | 50 | 50 |
| BET surface area | m²/g | 43 | 44 | 146 | 41 |
| Curie temperature | ° C. | 620 | 620 | 620 | 330 |
| Saturation | Am²/kg | 29.7 | 54.2 | 17.0 | 10.8 |
| magnetization | | | | | |
| | | Formulation | | | |
| Viscosity | | F-1 | F-2 | F-3 | F-4 |
| shear rate 25 s⁻¹ | Pa · s | 1.2 | 1.3 | 10.9 | 1.3 |
| shear rate 100 s⁻¹ | Pa · s | 1.2 | 1.3 | 11.2 | 1.3 |

*calculated for Fe₂O₃; domains contain Fe₂O₃ and Fe₃O₄;
**Fe₂O₃ 33 wt. %; MnO 4 wt. %, MgO 13 wt. %.

1: A formulation comprising a polymerizable monomer and/or a polymer and, dispersed therein, a superparamagnetic powder, characterized in that the superparamagnetic powder consists of aggregated primary particles, the primary particles being built up from magnetic metal oxide domains having a diameter of from 2 to 100 nm in a nonmagnetic metal oxide or metalloid oxide matrix.

2: The formulation according to claim 1, characterized in that the aggregate size of the superparamagnetic powder is greater than 100 nm and less than 1 μm.

3: The formulation according to claim claim 1, characterized in that the magnetic domains comprise iron oxide.

4: The formulation according to claim 1, characterized in that the magnetic domains comprise ferrites.

5: The formulation according to claim 1, characterized in that the magnetic domains are built up from ternary systems of the general formula (M^{a}_{1-x-y}M^{b}ₓFe_{y})^{II}Fe₂^{III}O₄, where Ma and M^{b}=manganese, cobalt, nickel, zinc, copper, magnesium, barium, yttrium, tin, lithium, cadmium, magnesium, calcium, strontium, titanium, chromium, vanadium, niobium or molybdenum and x=0.05 to 0.95, y=0 to 0.95 and x+y≦1.

6: The formulation according to claim 1, characterized in that the content of the magnetic domains in the superparamagnetic powder is 10 to 90 wt. %.

7: The formulation according to claim 1, characterized in that the superparamagnetic powder is present in the formulation in a range of from 0.1 to 40 wt. %.

8: The formulation according to claim 1, characterized in that the polymer is a polymer which can be softened thermoplastically, a one- or two-component polyurethane, a one- or two-component polyepoxide, a one- or two-component silicone polymer, a silane-modified polymer, a polyamide, a (meth)acrylate-functional polymer, a polyester, a polycarbonate, a cycloolefin copolymer, a polysiloxane, a poly(ether)sulfone, a polyether ketone, a polystyrene, a polyoxymethylene, a polyamide-imide, a polytetrafluoroethylene, a polyvinylidene fluoride, perfluoroethylene/propylene copolymer, perfluoroalkoxy copolymer, a methacrylate/butadiene/styrene copolymer and/or a liquid crystal copolyester (LCP).

9: The formulation according to claim 1, characterized in that the superparamagnetic powder is in the form of granules.

10: The formulation according to claim 1, characterized in that it is in the form of granules of polymer and superparamagnetic powder.

11. The formulation according to claim 1, characterized in that it additionally comprises organic dispersing agents.

12. A process for heating the formulation according to claim 1, wherein the formulation is exposed to a magnetic or electromagnetic alternating field.

13. (canceled)
